(19) United States
(12) Patent Application Publication
(10) Pub. No.: US 2026/0012872 A1
(43) Pub. Date: Jan. 8, 2026

(54) CARRIER AGGREGATION ASSIGNMENTS BASED ON CHANNEL CONDITIONS

(71) Applicant: T-Mobile USA, Inc., Bellevue, WA (US)

(72) Inventors: Sharath Somashekar, OVERLAND PARK, KS (US); Deveshkumar Narendrapratap Rai, Overland Park, KS (US)

(21) Appl. No.: 18/762,485

(22) Filed: Jul. 2, 2024

(51) Int. Cl. H04W 36/30; H04W 16/10; H04W 16/14; H04W 28/22; H04W 36/28

(52) U.S. Cl. CPC H04W 36/304; H04W 28/22; H04W 36/28; H04W 16/10; H04W 16/14

(57) ABSTRACT

Methods and systems for carrier aggregation based on channel conditions using a machine learning model are disclosed. According to an implementation, a computing system may receive, from a user equipment (UE), a request to increase a data transmission rate. The computing system may be associated with an access point of a wireless network. The computing device may request the UE to report a measured first parameter associated with a carrier assigned to the UE. Further, the computing device may obtain, from a network device, a second parameter associated with the carrier, the second parameter being measured by the network device. Based at least in part on the first parameter and the second parameter, and using a machine learning model, the computing device may determine a new carrier. The computing device may further assign, to the UE, the new carrier in response to the request to increase the data transmission rate.

### BACKGROUND

Carrier aggregation is widely used in mobile networks to boost data speeds. It involves using multiple carriers simultaneously to create a wider channel for data transmission. This results in increased data throughput and reduced latency, allowing for a more efficient and responsive mobile network. Carrier aggregation is made possible by the use of carrier aggregation capable devices, which are able to connect to multiple carriers at the same time. The assignment of individual carriers to the user equipment (UE) for carrier aggregation is traditionally based on UE capabilities, load on each of the carriers, and the traffic type. However, existing carrier aggregation mechanisms can sometimes result in UEs being assigned to carriers that are mismatched to the channel.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example scenario, in which carrier aggregation assignment is implemented according to an example of the present disclosure.

FIG. 2 illustrates an example scenario, in which carrier aggregation assignment is implemented according to another example of the present disclosure.

FIG. 3 illustrates an example scenario, in which carrier aggregation assignment based on channel conditions using a machine learning model is implemented according to an example of the present disclosure.

FIG. 4 illustrates an example scenario, in which carrier aggregation assignment based on a machine learning model is implemented according to another example of the present disclosure.

FIG. 5 illustrates an example process for carrier aggregation assignment based on channel conditions using a machine learning model according to an example of the present disclosure.

FIG. 6 illustrates an example computing device, in which methods for carrier aggregation assignment based on channel conditions using a machine learning model are implemented according to an example of the present disclosure.

### DETAILED DESCRIPTION

Techniques for carrier aggregation assignment based on channel conditions using a machine learning model are disclosed herein.

In some implementations, a method for carrier aggregation assignment based on channel conditions using a machine learning model may be implemented by a computing device or a computing system associated with an access network of a wireless service provider. The access network may include a plurality of access points to connect the user devices or user equipment to the core network of the wireless service provider. By way of example but without limitation, the access point may be a gNB associated with a Fifth Generation (5G) radio access network (RAN), and/or an eNB associated with a Fourth Generation (4G)/Long-Term Evolution (LTE) RAN.

The computing device may include a processor and a non-transitory computer-readable memory storing computer-executable instructions that, when executed by the processor, cause the processor to perform actions to determine carrier aggregation assignment by executing a machine learning model. In implementations, a user equipment (UE) may initially register to the core network of the wireless service provider through an access point. During the initial registration, the access point may assign one or more carriers to the UE based on UE reported capabilities, location of the UE, service requested by the UE, and the conditions of the available carriers. The one or more carriers, forming an aggregated carrier, may include a primary component carrier (PCC) and at least one secondary component carrier (SCC) (also referred to as an auxiliary component carrier). The primary component carrier is configured to transmit data and control signals between the UE and the access point. The secondary component carrier, when activated, is configured to transmit only data to enhance the data transmission rate between the UE and the access point. In implementations, the downlink channel and the uplink channel may be configured with different aggregated carriers. For example, the uplink channel may include more secondary component carriers than the downlink channel.

Upon the initial registration is completed, the primary component carrier may be used for data and control signal transmission, while the one or more secondary component carrier may be kept deactivated and can be activated when needed. In some examples, the computing device may receive a request from the UE to increase a data transmission rate after the initial registration. In some existing techniques, the request may cause a pre-assigned secondary component carrier to be activated. When the UE is assigned with more than one secondary component carrier, the secondary component carrier with a highest priority may be activated in response to the request. According to the present disclosure, such request may automatically trigger a carrier re-evaluation to determine the aggregated carrier to accommodate the request. In some examples, the carrier re-evaluation may include determining at least a secondary component carrier in the aggregated carrier.

The re-evaluation process may be performed using a machine learning model and based on a variety of parameters indicative of at least the UE measurement and channel conditions measured from the network side. The machine learning model may output a secondary component carrier that can more effectively support the UE request, which could be different from the pre-assigned secondary component carrier.

In implementations, the computing device may request the UE to report the measurement metrics associated with the carriers being assigned to the UE. For example, for each assigned carrier, the UE may report a reference signal received power (RSRP), a reference signal received quality (RSRQ), a reference signal strength indicator (RSSI), a signal-to-interference-plus-noise ratio (SINR), or a Channel Quality indicator (CQI).

The computing device may further obtain the performance/conditions of the assigned carriers measured at the network side, e.g., a user plane function of the core network. In some examples, data related to the performance/conditions of the assigned carriers may be stored in a database of the wireless service provider. The performance/conditions of a carrier may be represented by a usage of physical resource block (PRB), a number of subscribers attached to the carrier, a scheduler utilization ratio in the downlink (DL) and/or uplink (UL) directions, etc.

In some examples, the computing device may determine a current location of the UE or request the UE to report its location. Taking at least the UE reported measurement metrics, the UE location, the UE capabilities reported during the initial registration, and the performance/conditions of the carriers, as input to the machine learning model, the computing device may further execute the machine learning model to output a secondary component carrier in response to the UE's request.

The machine learning model may be trained by another computing device using at least one of a supervised learning algorithm or an unsupervised learning algorithm, and based on historical carrier assignment data. In some examples, the machine learning model may be implemented by one or more computing devices associated with the access network of the wireless service provider.

In some examples, the UE may move across a border of the serving cell, triggering a request for handover and cell re-selection. The computing device may re-assign the aggregated carrier using the machine learning model. In addition to considering the UE reported measurements and the performance/condition of the assigned carriers, the computing device may also consider the performance/condition of the available carriers associated with neighboring cells, which are not assigned to the UE during the initial registration. In implementations, the re-assignment of the aggregated carrier may include re-assigning the primary component carrier and one or more second component carriers to the UE.

The present disclosure performs carrier aggregation assignments by using a machine learning model based on the real-time channel conditions, the UE capabilities, the UE location, and the UE measurement for each available carrier. The carrier aggregation assignments can capture the dynamic changes of the available carriers/channels and aggregate the carriers that fit the needs of a specific UE, yet balancing the performance of the carrier/channels in the network.

The techniques discussed herein may be implemented in a computer network using one or more of protocols including but are not limited to Ethernet, 3G, 4G, 4G LTE, 5G, Sixth Generation (6G), the further radio access technologies, or any combination thereof wherever carrier aggregation concepts and principles apply. Example implementations are provided below with reference to the following figures.

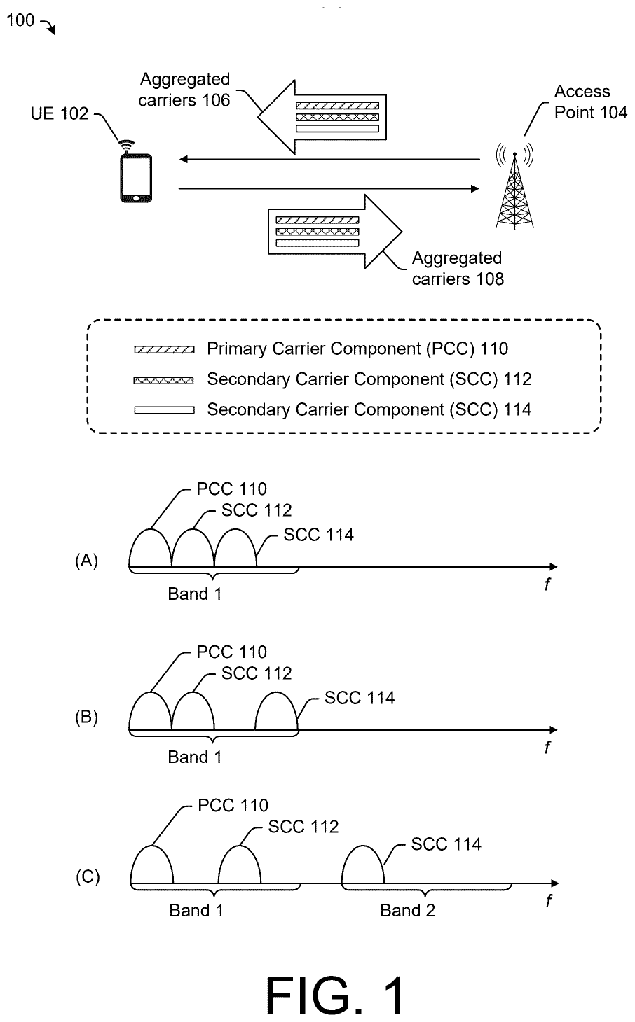

FIG. 1 illustrates an example scenario, in which carrier aggregation assignment is implemented according to an example of the present disclosure.

The scenario 100, as illustrated in FIG. 1, may be associated with a telecommunication network of a wireless service provider. A user equipment (UE) 102 may attach to a core network of the wireless service provider through an access point 104. In implementations, the access point 104 may be compatible with one or more radio access technologies, protocols, and/or standards, such as 5G New Radio (NR) technology, LTE/LTE Advanced technology, other fourth generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. For example, the access point 104 may be a gNB associated with a 5G radio access network (RAN) or an eNB associated with a 4G/LTE RAN. Although not shown, the access point 104 may also be associated with a second generation (2G) base station, a third generation (3G) NodeBs associated with GSM and CDMA access network, digital subscriber line (DSL) and variations of DSL technology that provide access to desktops, workstations, and/or mainframes, Wi-Fi connections to the user equipment, etc. The core network may be referred to as a backbone network of the telecommunication network, such as, a 5G core network, an evolved packet core (EPC) network, etc.

During an initial registration process, the UE 102 may report its capabilities to the access point 104. The capabilities normally describe the performance specifications of a user equipment and enable an access point to communicate effectively with the user equipment by knowing the specified performance parameters. For example, the capabilities may define that the UE 102 supports NR band or LTE band in a single carrier, UMTS and GSM, carrier aggregation band combination, etc. In circumstances that the UE 102 supports carrier aggregation, the access point 104 may determine a primary component carrier (PCC) (e.g., PCC 110) to transmit data and control signals in both downlink and uplink. In some examples, the access point 104 may add at least one secondary component carrier (SCC) (e.g., SCC 112 and/or SCC 114) to enhance data throughput in the downlink channel and/or the uplink channel. The aggregated carriers (e.g., a combination of PCC and at least one SCC) may be assigned to the UE 102. In some examples, the aggregated carrier 106 in the download channel may include a same number of SCCs as the aggregated carrier 108 in the uplink channel. In yet other examples, the aggregated carrier 106 in the download channel may include more SCCs than the aggregated carrier 108 in the uplink channel.

The UE 102 may be any device that can wirelessly connect to a telecommunication network. In some examples, the UE 102 may be a mobile phone, such as a smart phone or other cellular phone. In other examples, the UE 102 may be a personal digital assistant (PDA), a media player, a tablet computer, a gaming device, or any other type of computing or communication device. In yet other examples, the UE 102 may include the computing devices implemented on the vehicle including but are not limited to, an autonomous vehicle, a self-driving vehicle, or a traditional vehicle capable of connecting to internet. In yet other examples, the UE 102 may be a wearable device and/or wearable materials, such as a smart watch, smart glasses, clothes made of smart fabric, etc. In further examples, the UE 102 may be a virtual reality or augmented reality goggles or glasses. The UE may support various radio access technologies such as Bluetooth, Wi-Fi, GSM, CDMA, WCDMA, UMTS, 4G/LTE or 5G new radio (NR).

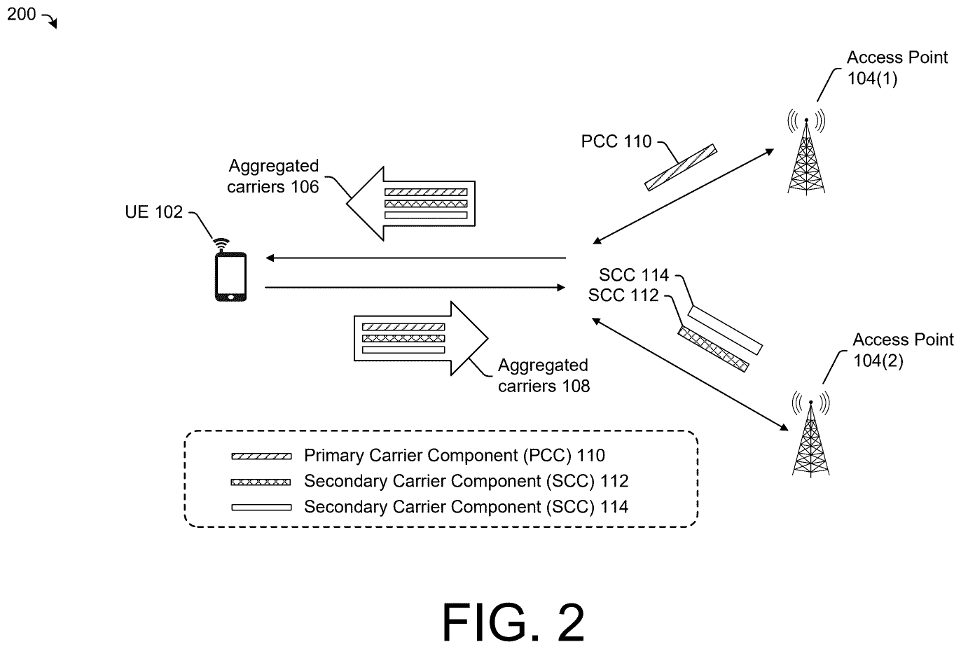

As discussed herein, frequency bands for 5G new radio may be separated into two different frequency ranges. Frequency Range 1 (FR1) includes frequency bands from 450 MHz to 6 GHZ, some of which overlaps the LTE frequency range. Frequency Range 2 (FR2) includes frequency bands from 24.25 GHz to 52.6 GHz. The duplex mode may include frequency division duplex (FDD) and time division duplex (TDD). One scenario of the carrier aggregation may be contiguous carrier aggregation that combines the adjacent component carriers in a same frequency band. In yet another scenario, the aggregated component carriers may be separated by a spectrum gap but still within the same frequency band. In yet another scenario, the aggregated component carriers may include multiple component carriers in different frequency bands. In some examples, the multiple component carriers may be from different access points. FIG. 2 illustrates an example scenario 200, in which the primary component carrier and one or more secondary component carriers are from different access points. As shown in the example scenario 200 of FIG. 2, the primary component carrier 110 is from the frequency band operating at an access point 104(1), and the secondary component carriers 112 and 114 are from the frequency bands operating at an access point 104(2).

In implementations, an aggregated carrier may include multiple secondary component carriers. The multiple secondary component carriers may be deactivated and can be activated at any time to increase data rates. For instance, when the user equipment needs more bandwidth, one of the multiple secondary component carriers may be activated to support the need for more bandwidth. The multiple secondary component carriers may be pre-configured with different priorities, and in general, the secondary component carrier with a highest priority is activated to increase the bandwidth. However, as these priorities are pre-configured during the initial registration, the secondary component carrier with the highest priority may not be suitable for the current cell and/or channel conditions. In another instance, the location of the user equipment may change, triggering cell reselection and/or handover, a pre-configured SCC may be set as the PCC, while the pre-configured PCC may be set as the SCC. However, only switching the roles of the pre-configured PCC and the pre-configured SCC also neglects the changes in channel conditions after the initial registration. The present disclosure implements a scheme to take the channel conditions, the location of the user equipment, and the UE reported measurement metrics, into consideration to re-evaluate the carrier aggregation dynamically. The present disclosure may use a machine learning model trained using past carrier assignment data to re-evaluate the carriers for aggregation.

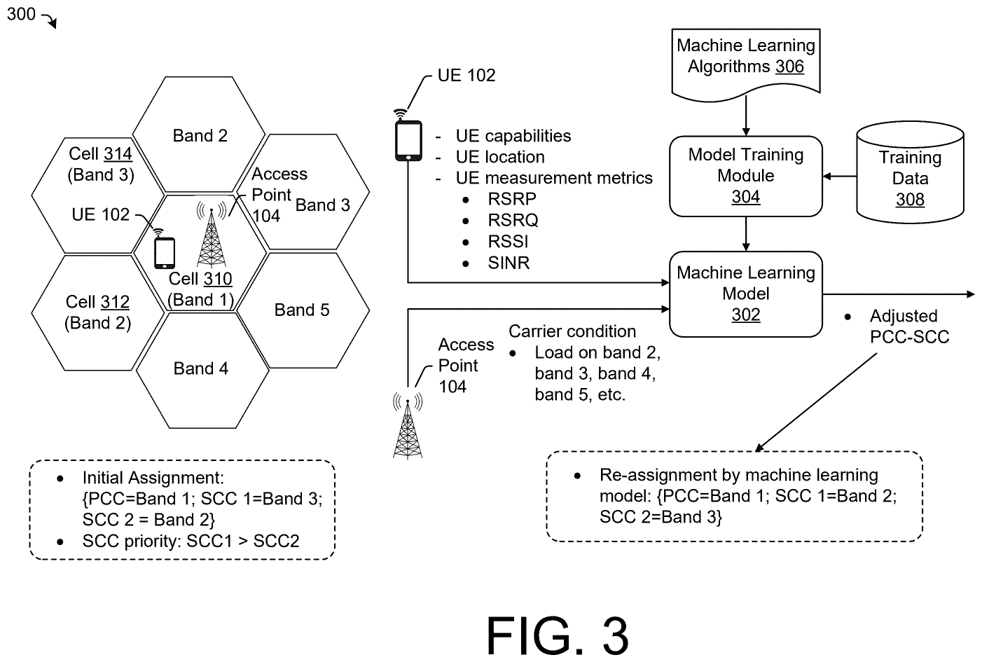

FIG. 3 illustrates an example scenario, in which carrier aggregation assignment based on channel conditions using a machine learning model is implemented according to an example of the present disclosure. The example scenario 300 illustrates a carrier aggregation assignment triggered by a UE request for higher data rates or bandwidth.

As illustrated in the example scenario 300, the UE 102 is located in a cell area, e.g., cell 310, served by the access point 104. The access point 104 may operate in a frequency band (e.g., Band 1) for uplink transmission to the UE 102. The frequency bands (e.g., Band 2, Band 3, Band 4, Band 5, etc.) in neighboring cells may also be available to use based on the location of the UE 102. During the initial registration process, the access point 104 may request the UE 102 to report its capabilities and/or location. The access point 104 may further measure the loads on neighboring frequency bands. Based on the UE reported capabilities and location, and the loads on neighboring frequency bands, the access point 104 may assign Band 1 operating in cell 310 as the PCC, and Band 2 operating in cell 312 and Band 3 operating in cell 314 as two SCCs for uplink transmission. In some examples, the access point 104 may also assign a priority indicator to each SCC. For instance, SCC1 (i.e., Band 3) is assigned with a higher priority than SCC2 (i.e., Band 2). The UE 102 may initially use PCC only for uplink transmission. At a later time, the PCC cannot support the data throughput required by the UE 102. According to an existing scheme, SCC1 having the highest priority is activated to support the data throughput.

As discussed herein, rather than activating the highest priority SCC, the present disclosure considers the real-time performance associated with the available carriers or channels and selects an SCC that can better support the UE. In some examples, when a request for a higher data rate is received, a machine learning model 302 implemented by a computing device (not shown) associated with the access point 104 may be triggered to re-evaluate the available carriers and determine an auxiliary carrier to support the UE 102. In implementations, the computing device may request the UE 102 to report a current location and measurement metrics of the associated carriers. In some examples, the current location of the UE 102 may be determined by the access point 104 based on the received signal strength. The UE 102 may report the measurement metrics including but not limited to, a reference signal received power (RSRP), a reference signal received quality (RSRQ), a reference signal strength indicator (RSSI), a signal-to-interference-plus-noise ratio (SINR), or a Channel quality indicator (CQI), etc. Further, the computing device may obtain the performance or condition of each carrier measured at the access point 104. For example, the access point 104 may measure the load of each carrier such as a number of physical resource blocks (PRBs) used in that carrier, a number of subscribers on that carrier, a scheduler utilization ratio in the DL and/or UL directions, etc.

The computing device may input the UE reported measurement metrics and location, and the carrier condition to the machine learning model 302. The UE capabilities reported at the initial registration may also be used as an input to the machine learning model 302. The computing device may execute the machine learning model 302 to determine, based on the UE reported capabilities, measurement metrics and location, and the carrier condition measured at the access point 104, a set of PCC and SCC. As the set of PCC and SCC determined by using the machine learning model 302 balances the UE reported measurement metrics and the real-time channel conditions, the aggregated carriers, even if different from the pre-set carrier aggregation, may support the UE's needs for a higher data rate more effectively. As shown in FIG. 3, a re-assigned carrier aggregation outputted by the machine learning model 302 may include Band 1 as the PCC, Band 2 as SCC1, and Band 3 as SCC2. In response to the UE's request for a higher data rate, Band 2, now having a higher priority, is activated. In some examples, the machine learning model 302 may output a pair of PCC and SCC in response to the UE's request. For example, the output from the machine learning model 302 may include Band 1 as the PCC and Band 2 as the SCC. The pair of PCC and SCC may then be assigned to the UE 102 to accommodate the request for higher data rate.

The machine learning model 302 may be periodically trained using a model training module 304 implemented on the same computing device and/or a separate computing device. The model training module 304 may train the machine learning model 302 by applying one or more machine learning algorithms 306 and based on training data 308. The one or more machine learning algorithms 306 may include supervised machine learning algorithm, unsupervised machine learning algorithm, semi-supervised machine learning algorithm, etc. The training data 308 may include data related to past carrier aggregation assignment. For example, a training data item may correspond to a past assignment of aggregated carriers, and include the frequency bands used as PCC and SCC, the carrier performance/conditions at the time of assignment, the UE reported measurement metrics at the time of assignment, the UE location at the time of assignment, the UE reported capabilities at the time of assignment, a triggering condition that caused the re-evaluation of PCC and SCC, etc. In implementations, the training data 308 may be divided into testing data set and validation data set. The training data 308 may be periodically updated to include the new carrier aggregation assignments. In some examples, the machine learning model 302 may be implemented by a computing device associated with multiple access points serving a geographic area.

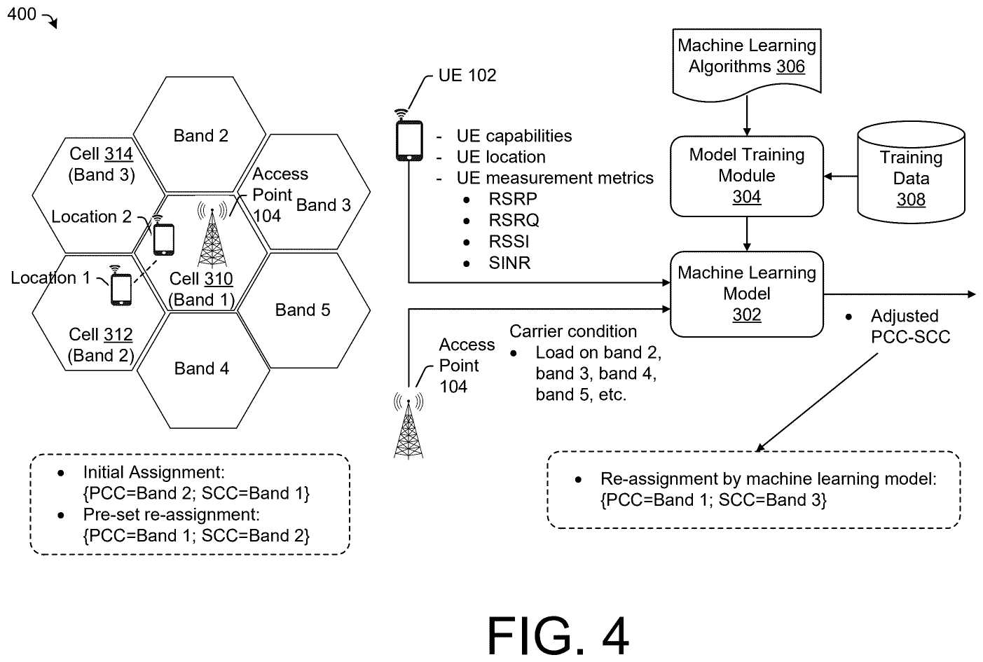

FIG. 4 illustrates an example scenario, in which carrier aggregation assignment based on a machine learning model is implemented according to another example of the present disclosure. The example scenario 400 illustrates a carrier aggregation assignment triggered by a cell re-selection or handover.

As illustrated in the example scenario 400, the UE 102 moves from location 1 within cell 312 to location 2 within cell 310. An initial assignment indicates that Band 2 operating in cell 312 is used as PCC and Band 1 operating in cell 310 is used as SCC. A pre-set carrier re-assignment may switch the roles of the PCC and the SCC when the user equipment moves from cell 312 to cell 310. According to the present disclosure, when the UE 102 roams across two cell areas, a handover request or cell re-select request may be received by the access point 104, triggering a carrier assignment re-evaluation. The machine learning model 320 running on the computing device may collect UE measurement metrics, UE location, and carrier load measured by the access point as the input and determine a carrier assignment. In some examples, the carrier load of the pre-set SCC (i.e., Band 2) may be high or exceed a threshold, the machine learning model 302 may select another carrier with lighter load to act as the SCC after handover. The output of the machine learning model 302 may indicate that Band 3 operating in cell 314 (instead of Band 2 operating in cell 312) may be set as the SCC after handover. In another example, the UE reported measurement metrics may show a carrier exhibits poor RSRP and/or RSSI. The machine learning model 302 may select another carrier that exhibits better performance to act as the SCC after handover.

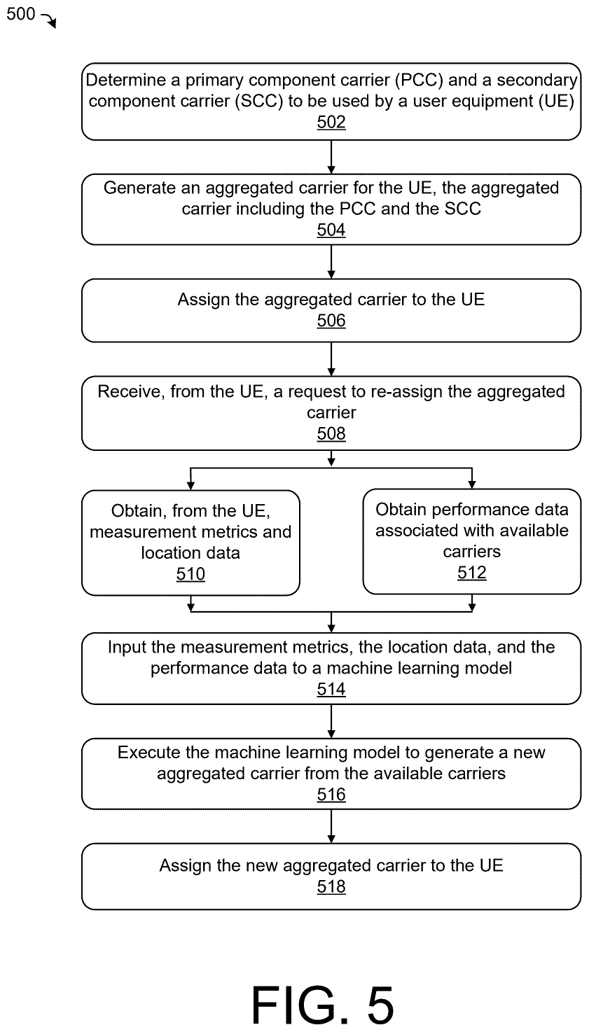

FIG. 5 illustrates an example process for carrier aggregation assignment based on channel conditions using a machine learning model according to an example of the present disclosure. The example process 500 may be performed by a computing device associated with an access point of the wireless network (e.g., the access point 104 shown in FIGS. 1-4).

At operation 502, the process may include determining a primary component carrier (PCC) and a secondary component carrier (SCC) to be used by a user equipment (UE). As discussed herein, when the user equipment attaches to the wireless network during the initial registration, an access point (e.g., base station, gNB, eNB, etc.) may determine the PCC and the SCC based on the UE reported capabilities and the carrier conditions. The uplink channel from the UE to the access point may have more SCCs than the downlink channel. In some examples, the uplink channel or the downlink channel may include two or more SCCs.

At operation 504, the process may include generating an aggregated carrier for the UE, the aggregated carrier including the PCC and the SCC. In implementations, the access point of the wireless network may create an aggregated carrier for downlink transmission and a separate aggregated carrier for uplink transmission.

At operation 506, the process may include assigning the aggregated carrier to the UE. As discussed herein, upon assigning the aggregated carrier to the UE, the access point and the UE agree on the certain frequency ranges (i.e., PCC) to be used to transmit data and control signals and one or more frequency ranges (i.e., SCCs) to be used to enhance the data rates. When the aggregated carrier includes multiple SCCs, the access point may configure each of the SCCs with a priority level. The priority level may indicate an order to activate the SCC when more data rates are needed.

At operation 508, the process may include receiving, from the UE, a request triggering a re-assignment of the aggregated carrier. The request triggering a re-assignment of the aggregated carrier include a request for more data rates, more bandwidth, etc. In some examples, the request may be generated because certain apps running on the UE cause a load on the PCC to approach or exceed a threshold. In some examples, the location of the UE may change, causing a request for handover and cell re-selection. Such request may also trigger a re-assignment of the aggregated carrier.

At operation 510, the process may include obtaining, from the UE, measurement metrics and location data. Upon receiving the request, the computing device may send a request for the UE to report the measurement metrics and location data. The measurement metrics includes one or more parameters indicative of the performance of the current carrier measured at the UE side. For example, the measurement metrics may include RSRP, RSRQ, RSSI, SINR, CQI etc. The UE may report its location using a global positioning system (GPS) running on the UE. Alternatively, or additionally, the access point may determine the position of the UE based on the measured signal strength from the network side.

At operation 512, the process may include obtaining performance data associated with available carriers. As discussed herein, the performance data associated with available carriers may be measured at the network side. The computing device may obtain the performance data measured at the access point. In implementations, the performance data may indicate the number of PRBs currently used in a certain frequency band, a number of user currently using the certain frequency band, how efficiently the scheduler is utilizing the PRBs, etc.

At operation 514, the process may include inputting the measurement metrics, the location data, and the performance data to a machine learning model. According to the present disclosure, a machine learning model is pre-trained to, based on the various inputs, generate an optimum carrier aggregation. In some examples, due to the current carrier performance or conditions, the optimum carrier aggregation may change the priority levels of the pre-assigned carriers.

At operation 516, the process may include executing the machine learning model to generate a new aggregated carrier from the available carriers. In some examples, the machine learning model may output a combination of the newly assigned PCC and the newly assigned SCC. In yet other examples, the machine learning model may output a combination of the newly assigned PCC and one or more newly assigned SCCs, where the one or more SCCs may be given new priority levels based on the current carrier performance.

At operation 518, the process may include assigning the new aggregated carrier to the UE. Upon receiving the new aggregated carrier, the operation of the UE may be switched to the newly assigned PCC for data and control signal transmission. If the UE requests for more data rates, the newly assigned SCC may be activated to support the request. If more than one SCC is assigned, the SCC with the new highest priority level may be activated to support the request.

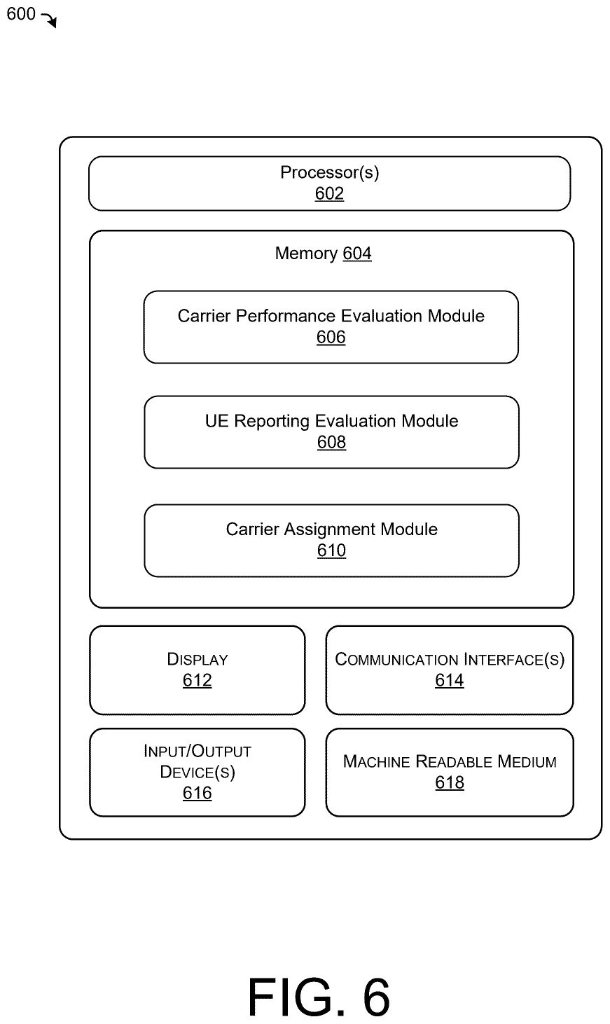

FIG. 6 illustrates an example computing device, in which methods for carrier aggregation assignment based on channel conditions using a machine learning model are implemented according to an example of the present disclosure. The example computing device 600 may correspond to the computing device associated with the access point of the wireless network.

As illustrated in FIG. 6, a computing device 600 may comprise processor(s) 602, a memory 604 storing a carrier performance evaluation module 606, a UE reporting evaluation module 608, and a carrier assignment module 610, a display 612, communication interface(s) 614, input/output device(s) 616, and/or a machine readable medium 618.

In various examples, the processor(s) 602 can be a central processing unit (CPU), a graphics processing unit (GPU), or both CPU and GPU, or any other type of processing unit. Each of the one or more processor(s) 602 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 602 may also be responsible for executing all computer applications stored in memory 604, which can be associated with common types of volatile (RAM) and/or nonvolatile (ROM) memory.

In various examples, the memory 604 can include system memory, which may be volatile (such as RAM), non-volatile (such as ROM, flash memory, etc.) or some combination of the two. The memory 604 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 600. Any such non-transitory computer-readable media may be part of the computing device 600.

The carrier performance evaluation module 606 may be configured to evaluate the carrier performance such as PRB usage, reported by the network side equipment, e.g., base stations, gNBs, eNBs, etc. The UE reporting evaluation module 608 may be configured to evaluate the UE reported metrics measured for each carrier such as RSRP, RSSI, SINR, CQI etc. The carrier assignment module 610 may execute a machine learning model (e.g., the machine learning model 302 shown in FIG. 3 and FIG. 4) to determine, based on the carrier performance evaluation and the UE reporting evaluation, a combination of the carriers to support the UE. As discussed herein, the combination of the carriers may indicate a primary component carrier and one or more secondary component carriers.

The communication interface(s) 614 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 614 can be compatible with multiple radio access technologies, such as 5G radio access technologies and 4G/LTE radio access technologies. Accordingly, the communication interfaces 614 can allow the computing device 600 to connect to the 5G system described herein.

Display 612 can be a liquid crystal display or any other type of display commonly used in the computing device 600. For example, display 612 may be a touch-sensitive display screen and can then also act as an input device or keypad, such as for providing a soft-key keyboard, navigation buttons, or any other type of input. Input/output device(s) 616 can include any sort of output devices known in the art, such as display 612, speakers, a vibrating mechanism, and/or a tactile feedback mechanism. Input/output device(s) 616 can also include ports for one or more peripheral devices, such as headphones, peripheral speakers, and/or a peripheral display. Input/output device(s) 616 can include any sort of input devices known in the art. For example, input/output device(s) 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, that embodies any one or more of the methodologies or functions described herein. The instructions can also reside, completely or at least partially, within the memory 604, processor(s) 602, and/or communication interface(s) 614 during execution thereof by the computing device 600. The memory 604 and the processor(s) 602 also can constitute machine readable media 618.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computing device, comprising:
a processor;
a non-transitory computer-readable memory storing computer-executable instructions that, when executed by the processor, cause the processor to perform actions including:
receiving, from a user equipment (UE), a request to increase a data transmission rate;
receiving, from the UE, a first parameter associated with a carrier assigned to the UE, the first parameter being measured by the UE;
obtaining, from a network device, a second parameter associated with the carrier, the second parameter being measured by the network device;
determining, based at least in part on the first parameter and the second parameter, and using a machine learning model, a new carrier; and
assigning, to the UE, the new carrier in response to the request to increase the data transmission rate.

2. The computing device of claim 1, wherein the first parameter includes at least one of:
a reference signal received power (RSRP),
a reference signal received quality (RSRQ),
a reference signal strength indicator (RSSI),
a signal-to-interference-plus-noise ratio (SINR), or
a channel quality indicator (CQI).

3. The computing device of claim 1, wherein the second parameter includes at least one of:
a physical resource block (PRB) usage of the carrier;
a number of subscribers using the carrier; or
a scheduler utilization ratio in at least one of a downlink (DL) or an uplink (UL).

4. The computing device of claim 1, wherein the computer-executable instructions, when executed by the processor, cause the processor to perform actions further including:
receiving, from the UE, capability parameters associated with the UE,
wherein the new carrier is further determined based on the capability parameters associated with the UE.

5. The computing device of claim 1, wherein the computer-executable instructions, when executed by the processor, cause the processor to perform actions further including:
receiving, from the UE, location data of the UE,
wherein the new carrier is further determined based on the location data of the UE.

6. The computing device of claim 1, wherein
the carrier includes a primary component carrier, and one or more of a first auxiliary component carrier and a second auxiliary component carrier,
wherein the first auxiliary component carrier is configured with a priority higher than the second auxiliary component carrier.

7. The computing device of claim 6, wherein the new carrier includes the primary component carrier, and one or more of the first auxiliary component carrier and the second auxiliary component carrier,
wherein the second auxiliary component carrier is configured with a priority higher than the first auxiliary component carrier.

8. The computing device of claim 7, wherein the computer-executable instructions, when executed by the processor, cause the processor to perform actions further including:
activating, through the network device, the second auxiliary component carrier to increase the data transmission rate.

9. The computing device of claim 1, wherein the machine learning model is trained using at least one of a supervised learning algorithm or an unsupervised learning algorithm, and based on historical carrier assignment data.

10. A computer-implemented method, comprising:
receiving, from a user equipment (UE), a request to increase a data transmission rate;
receiving, from the UE, a first parameter associated with a carrier assigned to the UE, the first parameter being measured by the UE;
obtaining, from a network device, a second parameter associated with the carrier, the second parameter being measured by the network device;
determining, based at least in part on the first parameter and the second parameter, and using a machine learning model, a new carrier; and
assigning, to the UE, the new carrier in response to the request to increase the data transmission rate.

11. The computer-implemented method of claim 10, wherein the first parameter includes at least one of:
a reference signal received power (RSRP),
a reference signal received quality (RSRQ),
a reference signal strength indicator (RSSI),
a signal-to-interference-plus-noise ratio (SINR), or
a channel quality indicator (CQI).

12. The computer-implemented method of claim 10, wherein the second parameter includes at least one of:
a physical resource block (PRB) usage of the carrier;
a number of subscribers using the carrier: or
a scheduler utilization ratio in at least one of a downlink (DL) or an uplink (UL).

13. The computer-implemented method of claim 10, further comprising:
receiving, from the UE, capability parameters associated with the UE,
wherein the new carrier is further determined based on the capability parameters associated with the UE.

14. The computer-implemented method of claim 10, further comprising:
receiving, from the UE, location data of the UE,
wherein the new carrier is further determined based on the location data of the UE.

15. The computer-implemented method of claim 10, wherein
the carrier includes a primary component carrier, and one or more of a first auxiliary component carrier, and a second auxiliary component carrier,
wherein the first auxiliary component carrier is configured with a priority higher than the second auxiliary component carrier.

16. The computer-implemented method of claim 15, wherein the new carrier includes the primary component carrier, and one or more of the first auxiliary component carrier, and the second auxiliary component carrier,
wherein the second auxiliary component carrier is configured with a priority higher than the first auxiliary component carrier.

17. The computer-implemented method of claim 16, further comprising:
activating, through the network device, the second auxiliary component carrier to increase the data transmission rate.

18. The computer-implemented method of claim 10, wherein the machine learning model is trained using at least one of a supervised learning algorithm or an unsupervised learning algorithm, and based on historical carrier assignment data.

19. A computer-readable storage medium storing computer-readable instructions, that when executed by a processor, cause the processor to perform operations comprising:
receiving, from a user equipment (UE), a request to increase a data transmission rate;
receiving, from the UE, a first parameter associated with a carrier assigned to the UE, the first parameter being measured by the UE;
obtaining, from a network device, a second parameter associated with the carrier, the second parameter being measured by the network device;
determining, based at least in part on the first parameter and the second parameter, and using a machine learning model, a new carrier; and
assigning, to the UE, the new carrier in response to the request to increase the data transmission rate.

20. The computer-readable storage medium of claim 19, wherein the first parameter includes at least one of:
a reference signal received power (RSRP),
a reference signal received quality (RSRQ),
a reference signal strength indicator (RSSI), or
a signal-to-interference-plus-noise ratio (SINR), or
a channel quality indicator (CQI).
